(19) United States
(12) Patent Application Publication
(10) Pub. No.: US 2006/0271300 A1
(43) Pub. Date: Nov. 30, 2006

(54) Systems and methods for microarray data analysis

(76) Inventors: William J. Welsh, Princeton, NJ (US); Ming Ouyang, Holmdel, NJ (US); Paul Lioy, Canford, NJ (US); Panos Georgopoulos, Princeton, NJ (US)

Correspondence Address: LICATA & TYRRELL P.C., 66 EAST MAIN STREET, MARLTON, NJ, 08053, US

(21) Appl. No.: 10/565,417

(22) PCT Filed: Jul. 29, 2004
(86) PCT No.: PCT/US04/24351

§ 371 Date: Aug. 3, 2006

Related U.S. Application Data
(60) Provisional application No. 60/491,635, filed on Jul. 30, 2003.

(51) Int. Cl. G06F 19/00

(52) U.S. Cl. 702/19; 702/20

(57) ABSTRACT

Clustering is routinely applied in the exploratory analysis of microarray data. Missing entries arise from blemishes on the microarrays. The present invention provides a new method, and computer program and/or computer product thereof to impute missing values. The method involves the steps of clustering microarray data by partitioning the data into a select number of clusters, wherein each data point is iteratively moved from one cluster to another, until two consecutive iterations have resulted in the same partition pattern; obtaining a select number of estimates of the data in the clusters by probabilistic interference; and averaging the select number of estimates to obtain missing values in the microarray data. The method is superior to other imputation models as measured by root mean squared errors.

### INTRODUCTION

This invention was made with government support under grant EPAR-827033 awarded by the US Environmental Protection Agency funded Center for Exposure and Risk Modeling (CERM) at EOHSI, grant ES0522 awarded by the National Institute of Environmental Health Sciences and grant GOB LM06230-03AI awarded by the NIH-NLM for Integrated Advanced Information Management Systems (IAIMS). The United States government may have certain rights in this invention.

### BACKGROUND OF THE INVENTION

Microarray analysis has revolutionized the field of molecular biology by replacing traditional research methods that rely on the analysis of one or a few genes or gene products at a time with an approach that is several orders of magnitude more powerful. Techniques based on gels, filters, and purification columns are giving way to biological chips that allow entire genomes to be monitored on a single chip, revealing the interactions among thousands of biological molecules and their responses to defined experimental conditions. The availability of genome information and the parallel development of microarray technology have provided the means to perform global analyses of the expression of an almost limitless number of genes in a single assay. With the completion of the human genome project and the availability of vast sequence data, the challenge is to identify the genes present in the genome, to characterize their function, to understand their interactions, and to determine their responses to drugs and other stimuli.

Microarray technology has found a plethora of applications, ranging from comparative genomics to drug discovery and toxicology, to the identification of genes involved in developmental, physiological, and pathological processes, as well as diagnosis based on patterns of gene expression that correlate with disease states and that may serve as prognostic indicators. DNA microarrays are instrumental in defining the molecular features of cancer progression and metastasis, and their use has allowed the classification of cancers of similar histopathology into further subgroups whose different responses to clinical protocols may now be systematically investigated. Microarrays can also be used to screen for single nucleotide polymorphisms (SNPs), small stretches of DNA that differ by only one base between individuals. The enormous power of microarray technology has paved the way for personalized medicine, in which the prescription of specific treatments and therapeutics will be tailored to an individual's genotype as a part of individualized therapy. Microarray technology can be used to analyze not only DNA, but also proteins, such as antibodies and enzymes, as well as carbohydrates, lipids, small molecules, inorganic compounds, cell extracts, and even intact cells and tissues.

A microarray chip is often no larger than a few square centimeters and can contain many thousands of samples. A single chip may contain the complete gene set of a complex organism, about 30,000 to 60,000 genes. The basic principle of DNA microarray analysis is base-pairing or hybridization. First, the probe molecules are synthesized as a set of oligonucleotides or harvested from a cell type or tissue of interest and deposited onto substrate-coated glass slides using highly precise robotic systems to produce arrays with thousands of elements spotted within an area of a few square centimeters. Next, differently labeled populations of target molecules are applied to the microarray and allowed to hybridize to the immobilized probes. Fluorescent dyes, usually Cy3 and Cy5, are used to distinguish probe pools from different samples that have been isolated from cells or tissues. After the slide is washed to remove nonspecific hybridization, it is read in a confocal laser scanner that can differentiate between Cy3- and Cy5-signals, collecting fluorescence intensities to produce a separate 16-bit TIFF image for each channel.

The fluorescence information is captured digitally and stored for normalization and image construction. The images produced during scanning for each fluorescent dye are aligned by specialized software to quantify the number of spots and their individual intensity and to determine and subtract background intensity. Once the primary image data have been collected from a microarray experiment, the aims of the first level of analysis are background elimination, filtration, and normalization, all of which contribute to the removal of systematic variation between chips, enabling group comparisons. Background noise is removed from microarrays by subtracting nonspecific signal from spot signal. Data are often then subjected to log transformation to improve the characteristics of the distribution of the expression values.

Microarray data analysis can yield enormous datasets. For example, an array experiment with ten samples involving 60,000 genes and 15 different experimental conditions will produce 9 million pieces of primary information. Cross comparisons of sample images can multiply this total many times over. These large collections of data necessitate not only large-scale information storage and management, but also require sophisticated analytical tools to interpret such vast quantities of raw data. Extracting meaningful biological information from the microarray data collected presents one of the most challenges in microarray bioinformatics. While a variety of mathematical procedures have been developed that partition the genes or other molecules in the microarray into groups with maximum pattern similarity, most microarray analysis techniques suffer from one major disadvantage: they are not robust to missing data in the microarray matrix.

Missing data in microarrays can arise from any number of technical problems, ranging from the robotic methods used for spotting, to weak fluorescence or resolution, to contamination and dust. In large-scale studies involving thousands to tens of thousands of genes and dozens to hundreds of experiments, the problem of missing entries becomes severe. Virtually every experiment contains some missing entries and more than 90% of the genes are affected. These missing values negatively affect the effectiveness of current methods for microarray analysis as many these methods generally require a full set of data. Therefore, the missing values need to be estimated or imputed.

The easiest solution to imputing missing values is to reiterate the experiment. However, this can be very expensive and unrealistic. Various statistical methods and their computational implementations have been used prior to the analysis process. The simplest computational approaches to microarray analysis with missing data will reduce the collected data by discarding missing records. If a record has missing data for any variable used in a particular analysis, the computer program will omit the entire record from the analysis, thereby eliminating the complete row. This practice leads to excessive loss of data points and the resulting analysis may no longer accurately represent the biological process under study. Data substitution approaches, such as replacing missing values with zeroes or row averages, are crude tools in that they do not take into account the correlation structure of microarray data, and therefore may result in biased or distorted data analysis.

A simple imputation method is to fill the missing entries with zeros (ZEROimpute). With some calculation, the row or column averages (ROWimpute and COLimpute) can be used. K-nearest neighbors (KNN) and singular value decomposition (SVD) imputation methods have also been used when the correlation structure of microarray data is taken into consideration. The KNN imputation method uses local patterns. The K records that are closest to the record with missing data are combined in the estimation and K is usually less than 100. The disadvantage of KNN imputation is that it uses the immediate neighbors of a gene to estimate the missing entries, which is subject to the local variability of microarray data. On the other hand, the SVD-based imputation method uses global patterns. All records, thousands to tens of thousands of them, are combined in the estimation. It appears that KNN provides more sensitive method for missing value estimation for genes that are expressed in small clusters and SVD provides a better mathematical framework for processing genome-wide expression data. However, both KNN and SVD may not be ideal solutions to imputing missing values in microarray data with intermediate cluster structures.

Therefore, there is a need to develop more efficient and a robust microarray analysis method capable of imputing missing data with accurate estimation. The present invention meets this long-felt need.

### SUMMARY OF THE INVENTION

The present invention relates to a method of imputing missing values in microarray data wherein said method involves the steps of clustering the microarray data with a Gaussian mixture clustering model and estimating the missing values through a GMCimpute algorithm.

The present invention also relates to a computer software program which, once executed by a computer processor, performs a method of imputing missing values in microarray data wherein the method involves the steps of clustering the microarray data with a Gaussian mixture model and estimating the missing values through a GMCimpute algorithm.

The present invention further relates to a computer program product encompassing a computer software program which, once executed by a computer processor, performs a method of imputing missing values in microarray data wherein said method involves the steps of clustering the microarray data with a Gaussian mixture model and estimating the missing values through a GMCimpute algorithm.

The present invention also relates to a computer encompassing a computer memory having a computer software program stored therein, wherein the computer software program, once executed by a computer processor, performs a method of imputing missing values in microarray data wherein said method involves the steps of clustering the microarray data with a Gaussian mixture model and estimating the missing values through a GMCimpute algorithm.

Particular embodiments of the present invention are set forth in the following drawing and description.

### BRIEF DESCRIPTION OF THE DRAWINGS

FIG. 1 shows the GMC imputation algorithm or the averaging Expectation-Maximization algorithm. GMCimpute constructs S models to impute the missing values; S is determined empirically. The first model treats the data as having one cluster, the second model treats the data as having two clusters, and so on. Each model partitions the data into the corresponding number of clusters (K), where each cluster is represented by a Gaussian distribution. The K Gaussian distributions are used to predict the missing values by the classic Expectation-Maximization algorithm, and the K estimates are combined into one estimate by a weighted average (in the EM_estimate procedure), where the weights are proportional to the probabilities that the datum belongs to the Gaussian distributions. Thus, each model results in one estimate for a missing entry. The estimate given by GMCimpute is the average of all the estimates by the S models.

### DETAILED DESCRIPTION OF THE INVENTION

The present invention relates to a method of imputing missing values in microarray data involving the steps of obtaining a set of microarray data with missing values; partitioning the data into a select number of clusters, wherein each data point is iteratively moved from one cluster to another, until two consecutive iterations have resulted in the same partition pattern; obtaining a select number of estimates from the clusters by probabilistic inference; and averaging the select number of estimates to obtain missing values in the microarray data.

Microarray technology allows a large number of molecules or materials to be synthesized or deposited in the form of a matrix on a supporting plate or membrane, commonly known as a chip. In one embodiment, a microarray, as used herein, includes a large number of molecules (also known as probe molecules) synthesized or deposited on a single microarray chip. The probe molecules interact with unknown molecules (target molecules) and convey information about the nature, identity, and/or quantity of the target molecules. The interaction between probe molecules and target molecules is generally via hybridization, such as base-pairing hybridization. Illustrative examples of microarrays include, but are not limited to, biochips, DNA chips, DNA microarrays, gene arrays, gene chips, genome chips, protein chips, microfluidics-based chips, combinatory chemical chips, or combinatory material-based chips.

In particular embodiments, a microarray is an oligonucleotide array or a spotted cDNA array. In an oligonucleotide array, an array of oligonucleotides (e.g., 20-80-mer oligonucleotides, or more suitably 30-mer oligonucleotides) or an array of peptide nucleic acid probes is synthesized either in situ (on-chip) or by conventional synthesis followed by on-chip immobilization. The oligonucleotide array is then exposed to labeled target DNA molecules, hybridized, and the identity and/or abundance of complementary sequences is determined. In the spotted cDNA array, probe cDNAs (e.g., 200 bp to 5000 bp in length) are immobilized onto a solid surface such as a microscope slide using robotic spotting. The spotted cDNA array is then exposed, contacted, or hybridized with differently, fluorescently labeled target molecules derived from RNA of various samples of interest. As known in the art, oligonucleotide arrays can be used for applications including identification of gene sequence/mutations and single nucleotide polymorphisms and monitoring of global gene expression. The spotted cDNA arrays can be used for, for example, genome-wide profile studies or patterns of mRNA expression.

Microarray data reflect the interaction between probe molecules and target molecules. As commonly known in the art, an illustrative example of microarray data is fluorescence emission readings derived from a microarray when target molecules are labeled with a set of fluorescent dyes (e.g., Cy3 and Cy5). The labeled target molecules interact or hybridize with the probe molecules synthesized or deposited on the microarray and the emission reading of fluorescence is detected through any means known in the art. The microarray emission is scanned and collected to produce a microarray image. Emission in each array cell of the microarray is taken to collectively produce microarray data wherein each array cell represents a data point.

In particular embodiments, microarray data are in the form of an m×n matrix, A. The m×n matrix, A used herein refers to a data matrix encompasses a total of M×N data sets which is the product of m and m. As used herein, m refers to the number of rows which correspond to the number of genes. In general, m is an integer and m≧1. In one embodiment, m≦10,000. As used herein, n refers to the number of columns which correspond to the experiments. In general, n is an integer and n≧1. In another embodiment, n≦1,000. Each data set in the matrix A is defined as A_{i,j} which is the emission of one array cell of microarray data at the position (i,j) in the matrix A. A_{i,j} also refers to the emission value of the array cell (i,j) and reflects the expression level of gene i in experiment j, wherein 1≦i≦m and 1≦j≦n. Aᵢ refers to the row i of A, which is the profile of gene i across the experiments. Aj refers to the column j of A, which is the profile of experiment j across the genes.

Analysis of Microarray Data. Microarray data, which contain substantial information regarding the entity and/or abundance of target molecules are commonly analyzed through data analysis tools or algorithms. One example of the data analysis tools includes clustering methods which partition microarray data set into clusters or classes, where similar data are assigned to the same cluster and dissimilar data belong to different clusters. Clustering can be applied to the rows of microarray data to identify groups of genes (or data points) of similar profiles, or to the columns to find associations among experiments. In one embodiment, the rows of microarray data are clustered. In another embodiment, the columns of microarray data are clustered. In general, it is desirable that the rows of microarray data are clustered.

Examples of clustering methods include hierarchical methods and relocational methods. Hierarchical clustering methods take a bottom-up approach and starts with each A_{i,j} as a singleton cluster. The closest pairs of clusters are found and merged. The dissimilarity matrix is then updated to take into account the merging of the closest pairs. Based on the new dissimilarity matrix information, another two closest distinct clusters are found and merged. The process is iterated until a single final cluster is formed. The final cluster encompasses all samples and is organized into a computed tree (commonly known as dendrogram) wherein genes with similar expression patterns are adjacent (Eisen, et al. (1998) Proc. Natl. Acad. Sci. USA 95:14863-8).

Gaussian mixture clustering is an example of a relocational method. K-means clustering (Hartigan (1975) Clutering Algorithms, Wiley, New York) corresponds to a special case of Gaussian mixture clustering (Celeux and Govaert (1992) Comput. Statist. Data Anal. 14:315-332). K-means clustering uses a top-down approach and starts with a specific number of clusters (e.g., K) and initial positions for the cluster centers (centroids). The procedure of the K-means clustering model follows the steps of 1) selecting K arbitrary centroids; 2) assigning each gene or cell data to this closest centroid; 3) adjusting the centroids to be the means of the samples assigned to them, and 4) repeating steps 2 and 3 until no more changes are observed. (Hartigan (1975) supra; Tibshirani, et al. (2001) J. R. Stat. Soc. B 63:411-423).

In one embodiment of present invention, microarray data are clustered through a Gaussian mixture clustering method (Yeung, et al. (2001) Bioinformatics 17:977-87; Ghosh and Chinnaiyan (2002) Bioinformatics 18:275-86). Gaussian mixture clustering (GMC) starts from an initial partition of the data points, GMC iteratively moves data points from one cluster (or component) to another, until two consecutive iterations have resulted in the same partition pattern. In other words, the partition has converged or the criterion of convergence is met.

In a Gaussian mixture clustering method, each component is modeled by a multivariate normal distribution. The parameters of component k encompass μₖ and Σₖ, and the probability density function is:

$${f}_{k} ( {A}_{i} \vert {μ}_{k} , {\sum }_{k} ) = \frac{exp \{ - \frac{1}{2} ( {A}_{i} - {μ}_{k}^{T} ) {\sum }_{k}^{- 1} ( {A}_{i}^{T} - {μ}_{k} ) \}}{{\vert 2 π {\sum }_{k} \vert}^{1 / 2}} .$$

As used herein, μₖ refers to a mean vector of k components and Σₖ refers to a covariance matrix.

The term k refers to the number of components in the mixture, and τₖ refers to mixing proportions: 0<τₖ<1, Σₖ τₖ=1. Then the likelihood of the mixture is:

$$L ( {μ}_{1} , {\sum }_{1} , … , {μ}_{K} , {\sum }_{K} \vert A ) = {\prod }_{i = 1}^{m} {\sum }_{k = 1}^{K} {τ}_{k} {f}_{k} ( {A}_{i} \vert {μ}_{k} , {\sum }_{k} )$$

wherein, Σₖ determines the geometric properties of component k. Banfield and Raftery ((1993) Biometrics 49:803-821) proposed a general framework for parameterization of Σₖ, and Celeux and Govaert ((1995) Pattern Recognition 28:781-793) discussed 14 parameterizations. The parameterization restricts the components to having some common properties, such as spherical or elliptical shapes, and equal or unequal volumes. Under an unconstrained model: Σₖ is the covariance matrix of the members in component k.

There are two steps in the Gaussian mixture clustering method when applied to estimating missing values. The first step initializes the mixture by partitioning the Aᵢ's into K subsets. The initial partition is obtained using the classic k-means clustering with the Euclidean distance to obtain the initial partition. The Euclidean distance is the de facto distance metric unless other metrics are justifiable. As described, K-means clustering (Hartigan (1975) supra) is a special case of Gaussian mixture clustering (Celeux and Govart (1992) supra). The K-means clustering itself requires the initial K means, and well-established methods (e.g., see Bradley and Fayyad (1998) 15th International Conference on Machine Learning, Madison, Wis.) can be used to compute them. Such methods generally compute an initial partition that leads to efficient and stable k-means clustering. For example, such a method can take 30 random and independent sub-samples of the data, where each sub-sample is 10% of the full set, and compute K-means clustering of the sub-samples with random initial partitions. The result is 30 sets of K means. Subsequently, the 30 K means are placed in one set, and the k-means of this set is computed. The resulting K means define the initial partition. Therefore, in the context of K means used herein, {C₁, . . . , C_{K}} is the partition.

The second step in clustering method uses the iterative Classification Expectation-Maximization algorithm (CEM; Banfield and Raftery (1993) Biometrics 49:803-821) to maximize the likelihood of the mixture. There are three steps in CEM: the Maximization step, the Expectation step, and the Classification step.

In the Maximization step, μₖ, Σₖ, and τₖ, k=1, . . . , K, are estimated from the partition; specifically,

$${μ}_{k} = \frac{{\sum }_{{A}_{i} ∈ {C}_{1}} {A}_{i}^{T}}{\vert {C}_{k} \vert} , \\ {\sum }_{k} = \frac{1}{\vert {C}_{k} \vert} {\sum }_{{A}_{i} ∈ {C}_{k}} ( {A}_{i}^{T} - {μ}_{k} ) ( {A}_{i} - {μ}_{k}^{T} ) , \\ {τ}_{k} = \frac{\vert {C}_{k} \vert}{m} .$$

In the Expectation step, the probabilities tₖ(Aᵢ) that Aᵢ is generated by component k, i=1, . . . , m, k=1, . . . , K, are computed; specifically,

$${t}_{k} ( {A}_{i} ) = \frac{{τ}_{k} {f}_{k} ( {A}_{i} \vert {μ}_{k} , {\sum }_{k} )}{{\sum }_{l = 1}^{K} {τ}_{l} {f}_{l} ( {A}_{i} \vert {μ}_{l} , {\sum }_{l} )} .$$

In the Classification step, the partition C₁, . . . , C_{K} is updated; Aᵢ is assigned to Cₖ if tₖ(Aᵢ) is the maximum among t₁(Aᵢ), . . . , t_{K}(Aᵢ). CEM repeats the three steps till the partition C₁, . . . , C_{K} converges. The partition has converged if two consecutive iterations of CEM have resulted in the same partition.

In the Gaussian mixture clustering method, the select number of clusters K is generally specified in advance, and usually remains constant throughout the iterations. There are several statistics that estimate the number of clusters, such as the statistic B (Fowlkes and Mallows (1983) J. Am. Stat. Assoc. 78:553-569), the silhouette statistic (Kaufman and Rousseeuw (1990) Finding groups in data: an introduction to cluster analysis, Wiley, New York) and the gap statistic (Tibshirani, et al. (2001) supra). Further, sampling procedures can be performed to determine the number of clusters (Levine and Domany (2001) Neural Comput. 13:2573-93; Yeung, et al. (2001) Bioinformatics 17:309-18; Ben-Hur, et al. (2002) Pac. Symp. Biocomput. 6-17). Moreover, with Gaussian mixture clustering, the Bayesian information criterion (BIC; Schwarz (1978) Ann. Stat. 6:461-464) and Bayes factor (Kass and Raftery (1995) J. Am. Stat. Assoc. 90:773-795) can be applied to select the number of clusters. In one embodiment of the present invention, the Bayesian information criterion is applied to select the number of clusters K in Gaussian mixture clustering. When several models are being considered to describe data, the traditional statistical test of hypothesis usually fails to refute any of the models; that is, none of the models show overwhelming evidence of being the wrong model. Nevertheless, some models are more preferable than others, as measured by the Bayesian information criterion. Thus, for use herein, let M₁, M₂, . . . , be the mixture clustering of 1, 2, . . . , components; let θₓ be the parameters of Mₓ: μ's, Σ's, and τ's. The integrated likelihood p(A|Mₓ) is defined as ∫p(A|θₓ,Mₓ) p(θₓ|Mₓ) dθₓ. As it can difficult to evaluate p(A|Mₓ), an approximation can be used in accordance with the BIC (Schwarz (1978) supra):
2 log p(A|Mₓ)≈2 log p(A|\hat{θ}ₓ,Mₓ)−vₓ log(m),
where \hat{θ}ₓ is the maximum likelihood estimate obtained by CEM, and vₓ is the number of parameters in Mₓ:

$${v}_{x} = xm + x ( \begin{matrix}m \\ 2\end{matrix} ) + x - 1.$$

One can choose K as the value of x that gives the maximum p(A|Mₓ), and use the Bayes factor (Kass and Raftery (1995) supra) B_{xy}=p(A|Mₓ)/p(A|M_{y}) to estimate the significance: a Bayes factor greater than 100 is considered decisively in favor of Mₓ.

Alternatively, K can be empirically decided. For example, K is a positive integer between 0 and 10,001, or an integer between 0 and 1,001, or more suitably an integer between 0 and 100. In a one embodiment, K is 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, . . . 40, . . . 50, . . . 60, . . . 70, . . . 80, . . . 90, or . . . 100.

Imputing Missing Data. Missing data, missing entries or missing values used herein refers to emission data that is missing for a number of array cells in a microarray. Array cells with missing data can be sporadically distributed in a microarray, or located in one or more rows of a microarray or one or more columns of a microarray, or any combination thereof. As is well-known in the art, missing values in microarray data occur for a variety of reasons, including insufficient resolution, image corruption, spill-over or contamination from adjacent cells, and dust or scratches on a microarray chip. Further, missing values can also occur systematically as a result of the robotic method used to synthesize or deposit probe molecules to form a microarray. Missing values negatively impact the effectiveness of current methods for microarray analysis. Accordingly, the present invention finds utility in the analysis of microarray data wherein missing values represent 50%, 30%, 25%, 20%, 15%, 10%, 5% or fewer of the total microarray data.

Missing values can be imputed via various methods. For example, the K-nearest neighbors (KNN) and singular value decomposition (SVD) methods can be used to impute missing values in the analysis of microarray data (Troyanskaya, et al. (2001) Bioinformatics 17:520-5). In the K-nearest neighbor imputation or KNNimpute, the classification of records from the given dataset takes place in several steps. First, all input/output pairs are stored in the training set. For each pattern in the test set the following steps should be done. The K nearest patterns to the input patterns are searched using Euclidean distance measure. For classification, the confidence for each class is computed as Cᵢ/K, where Cᵢ is the number of patterns among the K-nearest patterns belonging to class i. The classification of the input pattern is the class with the highest confidence. For estimation, the output value is based on the average of the output values of the K-nearest patterns.

For DNA microarray missing value analysis, the KNN-based method can select genes with expression profiles similar to the gene of interest to impute missing values. For example, wherein gene 1 has one missing value in experiment 1, this method would find K other genes, which have a value present in experiment 1, with expression most similar to gene 1 in experiments 2-N. A weighted average of values in experiment 1 from the K closest genes is then used as an estimate for the missing value in gene 1.

There are n columns in a microarray matrix A. When t is the number of missing entries in a row R, 1≦t<n, the missing entries are in columns 1, . . . , t. B is the complete rows of A without missing values. K-nearest neighbors or KNNimpute finds K rows, R₁, . . . , R_{K}, in B, that have the shortest Euclidean distances to R in the (n-t)-dimensional space (columns t+1, . . . , n). Wherein dₖ is the Euclidean distance from Rₖ to R, and R^{(j)} is the j-th column of R, then the missing entries of R are estimated by: for j=1, . . . , t,

$${R}^{( j )} = \frac{{\sum }_{k = 1}^{K} \frac{{R}_{k}^{( j )}}{{d}_{k}}}{{\sum }_{k = 1}^{K} \frac{1}{{d}_{k}}} .$$

In SVD or SVDimpute (Watkins (1991) Fundamentals of matrix computations, Wiley, New York), the matrix A with m×n data sets (m>n) is expressed as the product of three matrices: A=U Σ V^{T}, where the m by m matrix U and the n by n matrix V are orthogonal matrices, and Σ (not related to the covariance matrices of multivariate normal distributions) is an m by n matrix that contains all zeros except for the diagonal Σ_{i,i}, i=1, . . . , n. These diagonal elements are rank-ordered (Σ_{1,1}≧ . . . ≧Σ_{n,n}≧0) square roots of the eigenvalues of AA^{T}. The product of the first two or three columns of UΣ and the corresponding rows of V^{T} have been shown to capture the fundamental patterns in cell cycle data (Holter, et al. (2000) Proc. Natl. Acad. Sci. USA 97:8409-14).

Letting R₁, . . . , R_{K} be the first K rows of V^{T}, and letting R be a row of A with the first t entries missing, the estimation procedure of SVDimpute performs a linear regression of the last n-t columns of R against the last n-t columns of R₁, . . . , R_{K}. Letting cₖ be the regression coefficients, then the missing entries of R are estimated by: for j=1, . . . , t,

$${R}^{( j )} = {\sum }_{k = 1}^{K} {c}_{k} {R}_{k}^{( j )} .$$

SVDimpute first performs SVD on B, then it uses the estimation procedure on each incomplete row of A. Letting A′ be the imputed matrix, SVDimpute repeatedly performs SVD on A′, then updates A′ by the estimation procedure, until the Root Mean Squared Error (RMSE) between two consecutive A's falls below 0.01. ROWimpute has been used to compute the first A′ (Troyanskaya, et al. (2001) supra), however as demonstrated herein, the use of ROWimpute can introduce large errors to the imputed data which are subsequently propagated throughout the iterations.

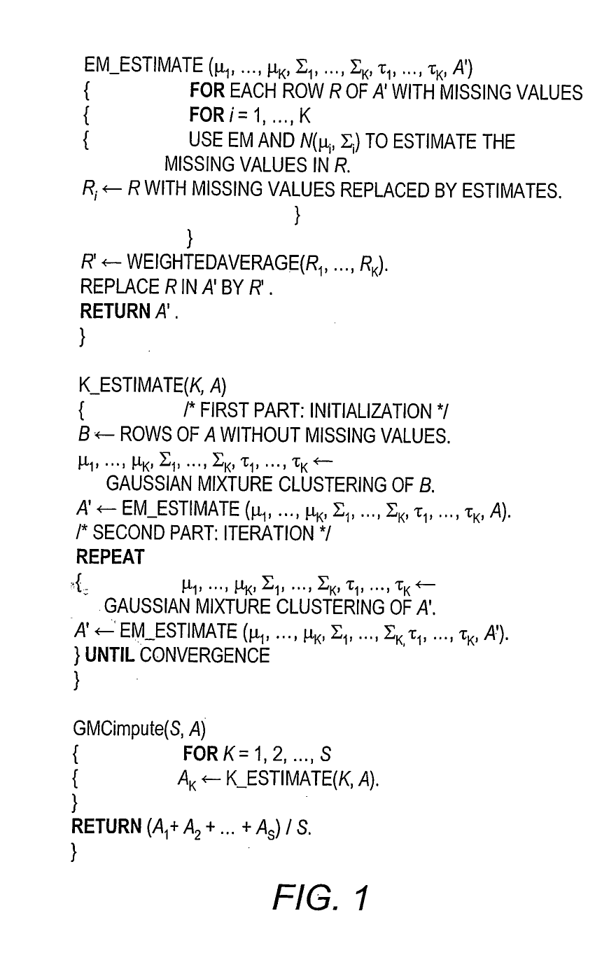

In one embodiment of the present invention, microarray data are evaluated by obtaining a select number of estimates of the data points in the clusters (obtained in the previous partitioning step) by probabilistic interference and averaging the select number of estimates to obtain the missing values. An exemplary method to carry out this step of the method of the present invention is the Gaussian mixture clustering method, wherein missing entries or missing values are estimated by an averaging Expectation-Maximization algorithm or a GMCimpute algorithm (FIG. 1). An illustrative example of the GMCimpute algorithm, as shown in FIG. 1, takes the average of all the K_estimates by S components. Accordingly, when one assumes that missing entries are permanently highlighted, the method of the present invention can still update the estimates even after GMCimpute inserts values. The method uses K_estimate to estimate the missing entries by 1, . . . , S-component mixtures. Each missing entry then has S estimates; the final estimate is the average of them.

The value of S can be empirically determined. S can be a positive integer between 0 and 10,001, S can be an integer between 0 and 1,001, or more suitably S can be an integer between 0 and 101. In particular embodiments, S is 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, . . . 40, . . . 50, . . . 60, . . . 70, . . . 80, . . . 90, or . . . 100. Once S is determined, microarray data (A) can have 1, 2, 3, . . . S components. Thus, K=1 when A has 1 component, K=2 when A has 2 components . . . K=S when A has S components.

Letting B be the complete rows of A, K_estimate has two parts. The first part initializes the missing entries by first obtaining the Gaussian mixture clustering of the complete rows of B, then estimating the missing entries by Expectation-Maximization (EM) algorithm or EM_estimate (For the Expectation-Maximization algorithm, see Dempster, et al. (1977) J. R. Stat. Soc. B 39:1-38; Ghosh and Chinnaiyan (2002) Bioinformatics 18:275-86). Letting A′ be the matrix with initial estimates, the second part consists of a loop that repeatedly computes the Gaussian mixture clustering of A′, and updates the estimates. After each pass through the loop, the present invention uses the parameters μ₁, . . . , μ_{K}, Σ₁, . . . , Σ_{K}, τ₁, . . . , τ_{K} to classify the rows of A′. Aᵢ′ is assigned to cluster k if τₖ(Aᵢ′) is the maximum among τ₁(Aᵢ′), . . . , τ_{K}(Aᵢ′). The loop is terminated when the cluster memberships of two consecutive passes are identical. The EM_estimate procedure uses the EM algorithm to estimate the missing entries row by row. To the simplify the notation, R, in addition to Aᵢ, is used as a row of the matrix. Since there are K components, each missing entry has K estimates: R₁, . . . , R_{K}. The weighted average R′ of Rₖ's is defined by:

$${R}^{′} = \frac{{\sum }_{i = 1}^{K} {R}_{i} {τ}_{i} {f}_{i} ( {R}_{i} \vert {μ}_{i} , {\sum }_{i} )}{{\sum }_{i = 1}^{K} {τ}_{i} {f}_{i} ( {R}_{i} \vert {μ}_{i} , {\sum }_{i} )} .$$

Thus, each component results in one estimate for a missing entry and therefore each missing entry has S estimates. The final missing value estimate is the average of S estimates which is defined as by: (A₁+A₂+A₃+ . . . +Aₛ)/S.

Computer Program and/or Product. It is desirable that missing values in microarray data are imputed through the use of a computer system. Accordingly, the present invention also relates to a computer software program which, once executed by a computer processor, performs a method of imputing missing values in microarray data in accordance with the method of the present invention. The present invention further relates to a computer program product involving a computer software program which, once executed by a computer processor, performs a method of imputing missing values in microarray data in accordance with the method of the present invention.

A computer system, according to the present invention, refers to a computer or a computer-readable medium designed and configured to perform some or all of the methods as desclosed herein. A computer, as used herein, can be any of a variety of types of general-purpose computers such as a personal computer, network server, workstation, or other computer platform currently in use or which will be developed. As commonly known in the art, a computer typically contains some or all the following components, for example, a processor, an operating system, a computer memory, an input device, and an output device. A computer can further contain other components such as a cache memory, a data backup unit, and many other devices well-known in the art. It will be understood by those skilled in the relevant art that there are many possible configurations of the components of a computer.

A processor, as used herein, can include one or more microprocessor(s), field programmable logic arrays(s), or one or more application-specific integrated circuit(s). Illustrative processors include, but are not limited to, INTEL® Corporation's PENTIUM® series processors, Sun Microsystems' SPARC® processors, Motorola Corporation's POWERPC™ processors, MIPS® processors produced by MIPS® Technologies Inc. (e.g., R2000 and R3000™ processors), Xilinx Inc.'s processors, and VIRTEX® series of field programmable logic arrays, and other processors that are or will become available.

An operating system, as used herein, encompasses machine code that, once executed by a processor, coordinates and executes functions of other components in a computer and facilitates a processor to execute the functions of various computer programs that can be written in a variety of programming languages. In addition to managing data flow among other components in a computer, an operating system also provides scheduling, input-output control, file and data management, memory management, and communication control and related services, all in accordance with known techniques. Exemplary operating systems include, for example, the readily available WINDOWS® operating system from the MICROSOFT® Corporation, UNIX® or LINUX™-type operating system, MACINTOSH® operating system form APPLE®, and the like or a future operating system, and some combination thereof.

As used herein, a computer memory can be any of a variety of known or future memory storage devices. Examples include, but are not limited to, any commonly available random access memory (RAM), magnetic medium such as a resident hard disk or tape, an optical medium such as a read and write compact disc or digital versatile disc, or other memory storage device. Memory storage device can be any of a variety of known or future devices, including a compact disk drive, a digital versatile disc drive, a tape drive, a removable hard disk drive, or a diskette drive. Such types of memory storage device typically read from, and/or write to, a computer program storage medium such as, respectively, a compact disk, a digital versatile disc, magnetic tape, removable hard disk, or floppy diskette. Any of these computer program storage media, or others now in use or that may later be developed, can be considered a computer program product. As will be appreciated, these computer program products typically store a computer software program and/or data. Computer software programs typically are stored in a system memory and/or a memory storage device.

An input device, as referred to herein, can include any of a variety of known devices for accepting and processing information from a user, whether a human or a machine, whether local or remote. Such input devices include, for example, modem cards, network interface cards, sound cards, keyboards, or other types of controllers for any of a variety of known input function. An output device can include controllers for any of a variety of known devices for presenting information to a user, whether a human or a machine, whether local or remote. Such output devices include, for example, modem cards, network interface cards, sound cards, display devices (for example, monitors or printers), or other types of controllers for any of a variety of known output function. If a display device provides visual information, this information typically can be logically and/or physically organized as an array of picture elements, sometimes referred to as pixels.

As will be evident to those skilled in the relevant art, a computer software program of the present invention can be executed by being loaded into a system memory and/or a memory storage device through one of input devices. On the other hand, all or portions of the software program can also reside in a read-only memory or similar device of memory storage device, such devices not requiring that the software program first be loaded through input devices. It will be understood by those skilled in the relevant art that the software program or portions of it can be loaded by a processor in a known manner into a system memory or a cache memory or both, as advantageous for execution.

As will be appreciated by those skilled in the art, a computer program product of the present invention, or a computer software program of the present invention, can be stored on and/or executed in a microarray instrument. A computer software of the present invention can be installed in a microarray instrument including GENEMACHINES® OMNIGRID™ robotic arrayer, Total Array System BioRobotics, or Amersham Array Spotter. A computer software or computer product of the present invention can also be installed or worked with a microarray instrument or a microarray analysis software provided by, for example, AFFYMETRIX®, AGILENT TECHNOLOGIES®, CORNING®, ILLUMNI™ (BEADARRAY™), INCYTE® (LifeArray), Oxford Gene Technology, SEQUENOM® Industrial Genomics (MASSARRAY™), Axon Instruments (GENEPIX®), Amersham Pharmacia Biotech, GeneData AG, LION Bioscience AG, ROSETTA INPHARMATICS™, Silicon Genetics, SPOTFIRE®, and Gene Logic. A computer program product of the present invention can be a part of a microarray instrument.

It is contemplated that it is not necessary that the computer program product or the computer software program be stored on and/or executed in a microarray instrument. Rather, the computer product or software can be stored in a separate computer or a computer server that connects to a microarray instrument through a data cable, a wireless connection, or a network system. As commonly known in the art, network systems comprise hardware and software to electronically communicate among computers or devices. Examples of network systems may include arrangement over any media including Internet, ETHERNET™ 10/1000, IEEE 802.11x, IEEE 1394, xDSL, BLUETOOTH®, 3G, or any other ANSI-approved standard. When the computer is linked to a microarray instrument through a network system, microarray data are sent out through an output device of the microarray instrument and received through an input device of a computer having the computer program product or software. The computer program product or the software then processes the microarray data and estimates missing values according to methods of the present invention. It is also contemplated that the microarray data can be stored in a server in a network system, the computer software of the present invention is executed in the server or through a separate computer, and resulting information is presented to a user in the presence of an output of a computer.

The following examples are provided to better illustrate the claimed invention and are not to be interpreted as limiting the scope of the invention. To the extent that specific materials are mentioned, it is merely for purposes of illustration and is not intended to limit the invention. One skilled in the art can develop equivalent means or reactants without the exercise of inventive capacity and without departing from the scope of the invention.

### EXAMPLE 1

### Simulation and Evaluation of Data

Missing entries were created as follows: each entry in a complete matrix of available microarray data was randomly and independently marked as missing with a probability p. For each of the two data sets used, four missing probabilities were used to render different proportions of missing entries. As an example, the yeast cell cycle data, http://rana.lbl.gov/EisenData.htm, (Eisen, et al. (1998) Proc. Natl. Acad. Sci. USA 95:14863-8) with 6221 genes (rows) and 80 experiments (columns) was used. The columns were correlated and some columns were replicated experiments. In the original data, each column had at least 182, and up to 765 missing entries. If a missing entry arises randomly and independently with probability p, then the expected number of genes with s missing entries is:

$${E}_{M} = 6221 ( \begin{matrix}80 \\ s\end{matrix} ) {{p}^{s} ( 1 - p )}^{80 - s} .$$

There were 3222 complete rows with no missing entries; solving for p when E_{M}=3222 and s=0 provides p≈0.0082. Similarly, 1583 rows had one missing entry, p≈0.0265; 478 rows had two missing entries, p≈0.0063; and 178 rows had three missing entries, p≈0.0088. The method of the present invention was used to evaluate the complete 3222 by 80 matrix, and missing probabilities of 0.003, 0.005, 0.007, and 0.009 in the simulations were applied.

The yeast environmental stress data (Gasch, et al. (2000) Mol. Biol. Cell 11:4241-57) in the Stanford Microarray Database (Sherlock, et al. (2001) Nucleic Acids Res. 29:152-5) contains 6361 rows and 156 columns with over a dozen stress treatments tested. After each treatment, the time-series expression data were collected. In contrast to the correlated columns in the cell cycle data, the stress data contained 156 columns that were uncorrelated representatives of gene expression under different conditions. For some treatments, there was a transient response and a stationary response in gene expression. As an example, Table 1 shows the two cliques of early and late time points of amino acid starvation that have large Pearson correlation coefficients within each clique.

TABLE 1

| Time | 0.5 hour | 1 hour | 2 hour | 4 hour | 6 hour |
|---|---|---|---|---|---|
| 0.5 hour | 1.000 | 0.647 | 0.353 | 0.342 | 0.413 |
| 1 hour | 0.647 | 1.000 | 0.575 | 0.408 | 0.445 |
| 2 hour | 0.353 | 0.575 | 1.000 | 0.497 | 0.435 |
| 4 hour | 0.342 | 0.408 | 0.497 | 1.000 | 0.694 |
| 6 hour | 0.413 | 0.445 | 0.435 | 0.694 | 1.000 |

Correlation coefficients greater than 0.6 are in boldface type.

In such a case, the time point with the fewest missing entries in a clique was chosen as the representative, thus denying the imputation methods the information embedded in correlated columns. Fifteen columns (Constant 0.32 mM H₂O₂ (80 minutes) redo; 1 mM menadione (50 minutes) redo; DTT (30 minutes); DTT (120 minutes); 1.5 mM diamide (10 minutes); 1 M sorbitol (15 minutes); hypo-osmotic shock (15 minutes); amino acid starvation (1 hour); amino acid starvation (6 hour); nitrogen depletion (30 minutes); nitrogen depletion (12 hour); YPD 25° C. (4 hour); YP fructose vs. reference pool; 21° C. growth; and DBY msn2msn4 0.32 mM H₂O₂ (20 minutes)) were chosen, and the Pearson correlation coefficients among them were all less than 0.6. In the 6361×15 original matrix, 5068 genes had no missing entries, p≈0.0150; 806 genes had one missing entry, p≈0.0097; 185 genes had two missing entries, p≈0.0188; and 63 genes had three missing entries, p≈0.0318. The complete matrix used was 5068 by 15, and missing probabilities of 0.01, 0.02, 0.03, 0.04 were applied in the simulations.

The simulation method consisted of taking a complete matrix; independently marking the entries as missing with probability p; separately applying GMCimpute, KNNimpute, SVDimpute, ROWimpute, COLimpute, and ZEROimpute to obtain imputed matrices; comparing the imputed matrices to the original one; and comparing the clustering of imputed data to that of the original data. This procedure was performed 100 times for each missing probability. One evaluation metric was the RMSE: the root mean squared difference between the original values and the imputed values of the missing entries, divided by the root mean squared original values of the missing entries. The other evaluation metric was the number of mis-clustered genes between the k-means clusterings of the original matrix and the imputed one. The value of K in k-means was determined using an established sub-sampling algorithm (Ben-Hur, et al. (2002) supra) and the statistic B of Fowlkes and Mallows (1983) supra). While hierarchical clustering has been used (Ben-Hur, et al. (2002) supra), k-means clustering was used herein to carry out the method of the present invention.

### EXAMPLE 2

### Imputation of Missing Values

The cell cycle data was represented by a 3222 by 80 matrix. For missing probability p equal to 0.003, 0.005, 0.007, and 0.009, the expected numbers of incomplete rows were 688, 1064, 1385, and 1659. The stress data was represented by a 5068 by 15 matrix. For p equal to 0.01, 0.02, 0.03, and 0.04, the expected numbers of incomplete rows were 709, 1325, 1859, and 2321. An incomplete row may have had more than one missing entry. As an example, for the cell cycle data with p equal to 0.009, the expected numbers of rows with 1, 2, 3, and 4 missing entries were 1136, 407, 96, and 26.

KNNimpute required the value of K, the number of nearest neighbors used in imputation. The values of K were set at 8 and 16 for cell cycle and stress data, respectively.

SVDimpute required the value of K, the number of vectors in V used in imputation. The values of K were set at 12 and 2 for cell cycle and stress data, respectively.

GMCimpute required the value of S: 1, 2, . . . , S-component mixtures were used in imputation. For cell cycle data, the values of S were set at 5, 3, 1, and 1 for missing probabilities 0.003, 0.005, 0.007, and 0.009. For stress data, the value of S was set at 7 for all missing probabilities.

The simulations compare six imputation methods by two evaluation metrics. The means and standard deviations of the first metric, RMSE, are listed in Table 2.

TABLE 2
Cell Cycle Data

| p | 0.003 | 0.005 | 0.007 | 0.009 |
|---|---|---|---|---|
| GMC | 0.48/0.03 | 0.48/0.02 | 0.48/0.02 | 0.49/0.02 |
| KNN | 0.62/0.03 | 0.63/0.02 | 0.63/0.02 | 0.64/0.02 |
| SVD | 0.59/0.04 | 0.59/0.03 | 0.59/0.02 | 0.60/0.02 |
| COL | 0.96/0.01 | 0.96/0.01 | 0.96/0.01 | 0.96/0.01 |
| ROW | 0.97/0.01 | 0.97/0.01 | 0.97/0.01 | 0.97/0.01 |
| 0 | 1.00/0.00 | 1.00/0.00 | 1.00/0.00 | 1.00/0.00 |

Stress Data

| p | 0.01 | 0.02 | 0.03 | 0.04 |
|---|---|---|---|---|
| GMC | 0.70/0.03 | 0.71/0.02 | 0.71/0.02 | 0.72/0.02 |
| KNN | 0.72/0.03 | 0.72/0.02 | 0.73/0.02 | 0.73/0.01 |
| SVD | 0.84/0.04 | 0.84/0.03 | 0.84/0.02 | 0.85/0.02 |
| COL | 0.96/0.02 | 0.96/0.02 | 0.96/0.01 | 0.96/0.01 |
| ROW | 1.00/0.00 | 1.00/0.00 | 1.00/0.00 | 1.00/0.00 |
| 0 | 1.00/0.00 | 1.00/0.00 | 1.00/0.00 | 1.00/0.00 |

The second metric requires the number of clusters in the data. Three and four clusters in the cell cycle and stress data, respectively, were found using sub-sampling, k-means clustering with the Euclidean distance, and the statistic B (sub-sampled statistics not shown). The means and standard deviations of the second metric, the number of mis-clustered genes, are listed in Table 3.

TABLE 3
Cell Cycle Data

| p | 0.003 | 0.005 | 0.007 | 0.009 |
|---|---|---|---|---|
| GMC | 3.8/3.4 | 5.0/4.7 | 5.7/4.6 | 7.5/5.5 |
| KNN | 4.4/3.5 | 5.8/3.9 | 8.3/5.4 | 10.0/5.6 |
| SVD | 4.3/3.9 | 5.6/4.0 | 7.9/4.8 | 8.9/5.8 |
| COL | 7.9/5.8 | 9.8/5.2 | 13.7/6.5 | 17.2/7.3 |
| ROW | 7.4/5.1 | 10.8/6.1 | 14.6/6.5 | 18.1/8.1 |
| 0 | 8.0/5.6 | 10.5/5.4 | 15.8/7.5 | 18.4/8.4 |

Stress Data

| p | 0.01 | 0.02 | 0.03 | 0.04 |
|---|---|---|---|---|
| GMC | 44/14 | 75/17 | 97/17 | 124/19 |
| KNN | 46/14 | 82/21 | 100/19 | 132/27 |
| SVD | 49/14 | 85/27 | 111/20 | 142/29 |
| COL | 60/17 | 95/15 | 128/19 | 163/21 |
| ROW | 59/22 | 93/19 | 126/21 | 160/25 |
| 0 | 57/12 | 93/18 | 125/18 | 162/50 |

GMCimpute, KNNimpute and SVDimpute were superior to the other imputation methods. GMCimpute was best among the three methods for both data sets, SVDimpute was better than KNNimpute on cell cycle data, and KNNimpute was better than SVDimpute on stress data. All observations had P values less than 0.05 by the paired t-tests and most of the P values were much less than 0.05.

### EXAMPLE 3

### General Discussion

In accordance with the method of the present invention, microarray data imputation was conducted using a RMSE having as a numerator defined as the root mean squared difference between the true values and the imputed values of the missing entries and a denominator defined as the root mean squared true values of the missing entries. This differs from the study of Troyanskaya, et al. ((2001) supra) wherein the RMSE numerator was the same as that disclosed herein and the denominator was the mean true values of the complete matrix. The advantage of the definition of the RMSE used herein is that ZEROimpute is always one, making it easy to compare imputation difficulty across data sets.

The stress data were more difficult for imputation than the cell cycle data. The difference in difficulty is apparent as evidenced Tables 2 and 3. There were at least two reasons for the difference in difficulty: the cell cycle data consisted of correlated columns, while the stress data, by choice, had all uncorrelated columns; and the cell cycle data had more columns than the stress data (80 versus 15). Therefore, it may be desirable when practicing the method of the present invention to use as many correlated columns as possible in the imputation.

Thus, it is apparent that GMCimpute is the best method in terms of RMSE (Table 2). SVD is commonly used in dimension reduction, but it requires a complete matrix. One way to obtain a complete matrix is to remove incomplete rows; however, with the cell cycle data, half of the original rows would be removed. Given the smaller RMSE of GMCimpute than SVDimpute, it is advantageous to use GMCimpute to fill in missing entries so as to work with a larger matrix in SVD analysis. Microarray data which has been put in the public domain has included cluster analysis, however, this analysis has generally lacked explicit implementation of imputation. Depending on the similarity measure used (such as Pearson correlation coefficient) and details of implementations, the implicit operations done for missing entries often corresponded to ROWimpute, COLimpute, or ZEROimpute. The findings presented herein indicate that well-known k-means clustering results can be improved by applying GMCimpute prior to clustering. The goal of imputation is not to improve clustering, but to provide unbiased estimates that would prevent biased clustering.

Accordingly, GMCimpute is the best method in terms of the second metric (Table 3); the number of mis-clustered genes is 19% to 64% less than ZEROimpute. It is thus evident that GMCimpute is a highly accurate and efficient method of imputing missing microarray data.

What is claimed is:

1. A method of imputing missing values in microarray data comprising the steps of:
(a) clustering the data by a Gaussian mixture clustering model; and
(b) estimating missing values by a GMCimpute algorithm
thereby imputing missing values in microarray data.

2. The method of claim 1, wherein the Gaussian mixture clustering model comprises the steps of
(a) determining a value of K;
(b) partitioning the rows of the microarray data into K partitions; and
(c) repeating a Classification Expectation-Maximization algorithm until the K partitions converge.

3. A computer program product comprising a computer software program, wherein the computer software program, once executed by a computer processor, performs a method of imputing missing values in microarray data according to the method of claim 1.

4. The computer program product of claim 3, wherein the Gaussian mixture clustering model comprises the steps of
(a) determining a value of K;
(b) partitioning the rows of the microarray data into K partitions; and
(c) repeating a Classification Expectation-Maximization algorithm until the K partitions converge.

5. A computer software program, wherein the computer software program, once executed by a computer processor, performs a method of imputing missing values in microarray data according to the method of claim 1.

6. The computer software program of claim 5, wherein the Gaussian mixture clustering model comprises the steps of
(a) determining a value of K;
(b) partitioning the rows of the microarray data into K partitions; and
(c) repeating a Classification Expectation-Maximization algorithm until the K partitions converge.

7. A computer comprising a computer memory having a computer software program stored therein, wherein the computer software program, once executed by a computer processor, performs a method of imputing missing values in microarray data according to the method of claim 1.

8. The computer of claim 7 wherein the Gaussian mixture clustering model comprises steps of
(a) determining a value of K;
(b) partitioning the rows of the microarray data into K partitions; and
(c) repeating a Classification Expectation-Maximization algorithm until the K partitions converge.
